(19) United States
(12) Patent Application Publication
(10) Pub. No.: US 2014/0324677 A1
(43) Pub. Date: Oct. 30, 2014

(54) METHOD AND SYSTEM FOR DETECTING, MONITORING AND INVESTIGATING FIRST PARTY FRAUD

(71) Applicant: JPMORGAN CHASE BANK, N.A., NEW YORK, NY (US)

(72) Inventors: Amy Moye Walraven, Lincoln University, PA (US); Seth Marshal Goldkrantz, Devon, PA (US); Rayna Halpin, Newark, DE (US)

(21) Appl. No.: 14/056,261

(22) Filed: Oct. 17, 2013

Related U.S. Application Data
(63) Continuation of application No. 12/468,293, filed on May 19, 2009.
(60) Provisional application No. 61/054,253, filed on May 19, 2008.

(51) Int. Cl. G06Q 20/40

(52) U.S. Cl. CPC G06Q 20/4016
USPC 705/39

(57) ABSTRACT

According to an embodiment of the present invention, a computer implemented method and system for identifying fraudulent situations includes monitoring customer activity data associated with an account using the programmed computer processor via the network, wherein the customer activity data comprises a combination of transaction activity, payment activity, and non-monetary activity; applying a prediction algorithm to the customer activity data to identify one or more dusters associated with the account, wherein the one or more clusters are associated with one or more other accounts; and providing one or more recommended treatments for the account and the one or more other accounts through an interface.

### CROSS REFERENCE TO RELATED APPLICATIONS

This application claims priority to United States provisional patent application titled “Method and System for Detecting, Monitoring and Investigating First Party Fraud,” filed on May 19, 2008, and assigned Application Ser. No. 61/054,253.

### FIELD OF THE INVENTION

The present invention relates generally to detecting, monitoring and investigating fraudulent activity, and more specifically to identifying first party fraud situations using a clustering or prediction algorithm.

### BACKGROUND OF THE INVENTION

Currently, fraud detection is a manual process that involves culling through billions of transactions to find fraud patterns. Fraud detection is not an exact science and often transactions from good customers are declined as well as fraudsters, thereby negatively impacting customer relations. The timeliness of fraud detection is also a major concern. If fraudulent activities are not detected early, fraudsters can make a major negative impact and cause substantial losses to merchants, financial institutions and other entities.

First party fraud involves the situation where a customer intentionally defrauds an entity (e.g., bank, financial institution, merchant, provider, etc.) without a third party victim. This may also be known as bust outs and synthetic fraud, for example. As a victim is nonexistent, first party fraud is harder to detect and oftentimes goes undetected longer thereby causing greater damage and loss.

First party fraud can occur in various ways. For example, an individual may use a card product and send in large checks thereby inflating their open to buy (OTB). The individual may then make large purchases and/or secure cash advances. OTB may refer to merchandise budgeted for purchase during a certain time period that has not yet been ordered. Within days, the checks will bounce. The typical loss is less than $15,000 but can exceed $100,000 or more. In another example, groups of individuals may team up to “trick” the process via authorized users and exploiting a bank's multiple relationship strategies. The groups may also involve collusive merchants. This type of scam can last over several years. In a typical scenario, members of the group will suddenly vanish around the same time period. The typical loss can range from $50,000 to over $1,000,000. In yet another example, complex rings may involve identity creation, synthetic identifications, merchants, gangs, buying identifications, foreign rings, etc. The typical loss can be multi-million dollars industry wide.

A main obstacle with first party fraud detection is the difficulty in detection because the fraudsters can mimic the behavior of a best customer. Current fraud tools do not account for such fraudulent activities and are not effective in addressing this type of fraud.

Other drawbacks may also be present.

### SUMMARY OF THE INVENTION

Accordingly, one aspect of the invention is to address one or more of the drawbacks set forth above. According to an embodiment of the present invention, a method and system for detecting, monitoring and investigating first party fraud through a clustering or prediction algorithm.

According to an exemplary embodiment of the present invention, an automated computer implemented method for identifying fraudulent situations, wherein the method is executed by a programmed computer processor which communicates with a user via a network, the method comprising the steps of: monitoring customer activity data associated with an account using the programmed computer processor via the network, wherein the customer activity data comprises a combination of transaction activity, payment activity, and non-monetary activity; applying a prediction algorithm to the customer activity data to identify one or more clusters associated with the account, wherein the one or more clusters are associated with one or more other accounts; and providing one or more recommended treatments for the account and the one or more other accounts through an interface.

In accordance with other aspects of this exemplary embodiment of the present invention, the method may further include merging an output of the prediction algorithm with a risk indication and prioritizing the at least one account with respect to other accounts. The one or more recommended treatments may address first party fraud. The transaction activity may include a combination of data comprising high risk purchases, frequency of transactions, transaction velocity, use of convenience checks and use of balance transfers. The payment activity may include a combination of data comprising payment frequency, payment amount and frequency of payment reversals. The non-monetary activity may include a combination of data comprising frequency of payment status inquiries, frequency of credit line increase requests, number of trade lines and geographic location. The one or more clusters may be identified through a Automatic Number Identification (ANI) associated with the at least one account. The one or more clusters may be identified through a Demand Deposit Account (DDA) associated with the at least one account. The prediction algorithm may generate a score representing likelihood of a first party fraud associated with the at least one account.

According to an exemplary embodiment of the present invention, a computer implemented system for identifying fraudulent situations, wherein the system is executed by a programmed computer processor which communicates with a user via a network, the system comprising: an analyze accounts module for monitoring customer activity data associated with an account using the programmed computer processor via the network, wherein the customer activity data comprises a combination of transaction activity, payment activity, and non-monetary activity; a clustering algorithm module for applying a prediction algorithm to the customer activity data to identify one or more clusters associated with the account, wherein the one or more clusters are associated with one or more other accounts; and a treatment module for providing one or more recommended treatments for the account and the one or more other accounts through an interface.

### BRIEF DESCRIPTION OF THE DRAWINGS

In order to facilitate a fuller understanding of the present inventions, reference is now made to the appended drawings. These drawings should not be construed as limiting the present inventions, but are intended to be exemplary only.

FIG. 1 is an exemplary diagram of a system for monitoring and/or detecting first party fraud and/or other fraud activities, according to an embodiment of the present invention.

FIG. 2 is an exemplary detailed diagram of a processor for monitoring and/or detecting first party fraud, according to an embodiment of the present invention.

FIG. 3 is an exemplary flowchart illustrating a method for identifying fraudulent events, according to an embodiment of the present invention.

FIG. 4 is an exemplary diagram illustrating a bust out prediction method, according to an embodiment of the present invention.

FIG. 5 is an exemplary interface illustrating a clustering algorithm, according to an embodiment of the present invention.

FIG. 6 is an exemplary interface illustrating detailed cluster data, according to an embodiment of the present invention.

FIG. 7 illustrates merging a clustering or prediction model with a credit score, according to an embodiment of the present invention.

### DETAILED DESCRIPTION OF EXEMPLARY EMBODIMENT(S)

An embodiment of the present invention improves efficiency of identifying potential fraudulent activities. An embodiment of the present invention is directed to analyzing data and creating links to identify anomalies in the data for first party fraud identification. A growing concern involves organized groups or individuals who ban together to defraud a financial institution, merchants and/or other providers. The fraudulent activities may be committed on various products, such as credit cards, accounts, lines of credit, mortgages, personal loans, student loans, business loans, etc.

One example of first part fraud may involve opening accounts for a fictional person. The fictional person may be created with valid social security numbers or other seemingly valid identification. Another example of first party fraud may include creating multiple versions of an actual person—this fraudster may create multiple accounts with different providers in different geographic areas. Another type of fraudster is someone who mimics a model customer by engaging in many lines of business and maintaining good credit. This fraudster may gradually apply for credit over an extended person of time. Another fraudster may immediately open many accounts and max out on some or all of these accounts simultaneously or within a period of time. Another example of first party fraud may be committed by a person under duress. For example, someone may be threatened to open up accounts for use by the fraudster.

The fraudster may be one person or a group of people managing one fraud account or many accounts. In addition, a fraudster may create fake businesses (e.g., perfume stores, jewelry stores, electronics store, etc.) to make fraudulent transactions. First party fraud is harder to detect because a victim does not exist and some or all parts of the personal information are true.

An embodiment of the present invention may identify first party fraud clusters. A cluster may be identified by analyzing data based on various factors through a clustering algorithm of an embodiment of the present invention. For example, the system may recognize that a customer has recently purchased hundreds of pre-paid phones. In this example, the system may recognize that pre-paid phones are often used by fraudsters. The system may also recognize that this person is staying at a motel in a major city. Once a fraudster or a cluster is identified, the system may then use this fraudster's information to identify other links to other potential fraudsters using the same or similar methodology.

An embodiment of the present invention may analyze customer activity to identify links and/or patterns. For example, the system may identify links within a central geographic location (e.g., address, hotel room number, etc.), use of same checking account, use of same phone number, frequent purchases from the same or associated merchants, activation of accounts within a short time frame of each other and/or other activities.

Other data may include: (1) Account information (e.g., Address, Phone, Business Phone, Social Security/Tin, Name, date of birth (DOB), Authorized Users, etc.); (2) Contact information (e.g., Inbound numbers, IP Address, Computer ID's, Call in type—cell, payphone, etc., Distance from source/Geographically location, etc.); (3) Activity (e.g., Transactions, Merchants, demand deposit account (DDA), Payees, Non monetary activity and change requests, etc.); (4) Other data (e.g., social security number (SSN) details (geography, time issued, etc.), utility information, cell phone information—type, carrier, location, retail information (e.g., internal and external), mortgage data (e.g., date issued, location, issuer, primary and holders, etc.), business data, TIN, owners, license data, financials, merchant ownership, bureau data—in file date, authorized user trades, balances timing, inquiries, auto data, drivers license, insurance, place of study, worship, clubs, social groups, professional affiliations, etc.; (5) Card information (e.g., Account Open timing, Acquisition channel, Product, Credit balances, Status, Usage, Payment trends, etc.).

Once a fraud cluster is identified, various actions may be invoked. The person or cluster may be flagged as a potential risk and/or placed under a close watch or supervision. The person or cluster may be forwarded to a high risk review. Depending on the level of urgency, the person or cluster may be immediately shut down. Other actions depending on the risk level or other considerations may be applied.

Another response may involve a close monitor of the identified person or cluster and/or continued search for related fraudsters. Generally, once one member of a group is found, the system may identify common elements (e.g., bad account numbers, names, addresses, etc.) or other links to identify the remaining members. If most or all accounts in a ring are not closed within the same time frame, the remaining open accounts rapidly go “bad” thereby increasing the damages. Thus, the system may perform a concerted shut-down on some or all members.

Another response may involve forwarding the information to an investigative bureau (e.g., police, FBI, secret service, etc.). The information may also be shared with financial institutions, merchants, private entities, government agencies and/or other entities.

In addition, an embodiment of the present invention may use identification technology to assist in locating and capturing fraudsters. For example, merchant locations (e.g., stores, gas stations, etc.) as well as other service locations (e.g., ATM, banks, etc.) may use real time data and/or images to capture the identified fraudster during a transaction. This information may then be used to identify the fraudster and provide further proof of fraudulent activities.

Another exemplary application may involve monitoring the use of Radio Frequency Identification (RFID) technology as well as other tokens, devices, cell phones, PDAs, etc. This information may also assist in tracking the fraudster and identify his/her immediate whereabouts.

While the detailed description is directed to an exemplary application involving first party fraud, the various embodiments of the invention may be applied to other scenarios and applications involving other fraudulent activities or other activities involving cluster data. Other applications may be applied in varying scope.

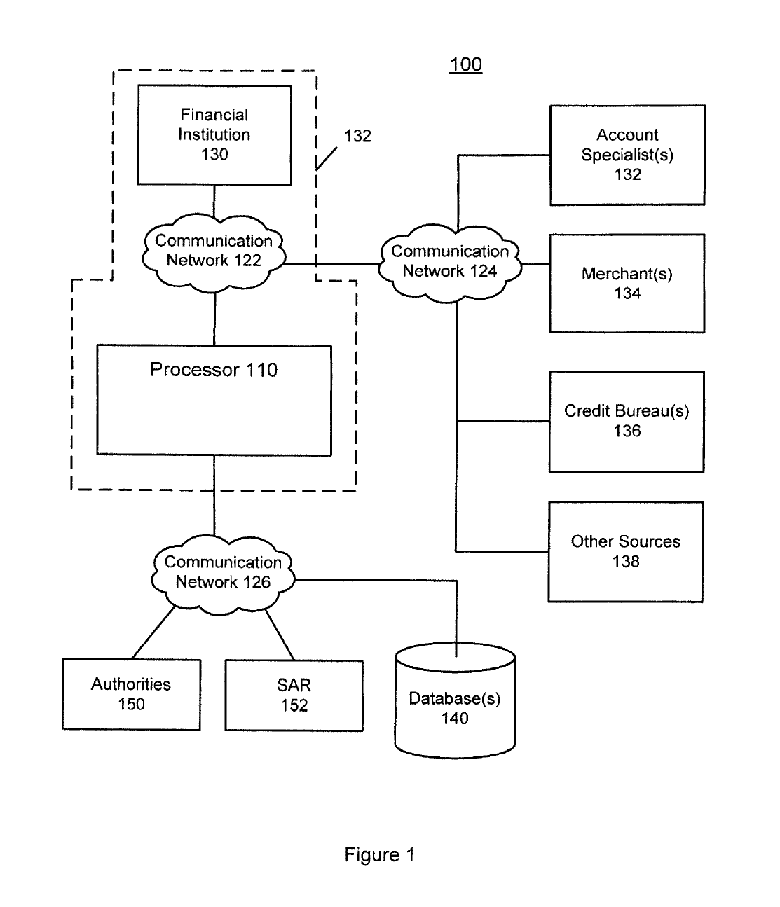

FIG. 1 is an exemplary diagram of a system for monitoring and/or detecting first party fraud and/or other fraud activities, according to an embodiment of the present invention. A system 100 of an embodiment of the present invention may include a Processor 110, which may be stand alone, hosted by an entity, such as a financial institution, service provider, bank, etc. For example, Processor 110 may be affiliated or associated with a financial institution, bank and/or other entity with fraud concerns. In an exemplary embodiment involving a financial institution such as 130, the financial institution may host or support the Processor. In this example, the application of the cluster algorithm of an embodiment of the present invention may appear to be performed by financial institution, as a single consolidated unit, as shown by 132.

According to another example, Processor 110 may be separate and distinct from Financial Institution 130. For example, Financial Institution 130, or other entity, may communicate to Processor 110 via a network or other communication mechanism, as shown by 122. While a single illustrative block, module or component is shown, these illustrative blocks, modules or components may be multiplied for various applications or different application environments. In addition, the modules or components may be further combined into a consolidated unit. Other architectures may be realized. The modules and/or components may be further duplicated, combined and/or separated across multiple systems at local and/or remote locations.

Processor 110 may access databases and/or other sources of information to identify fraud situations and/or other relevant information for effectively identifying fraudulent and potentially fraudulent events. For example, Processor 110 may access and/or maintain Database 140 and/or other database 142. Database 140 may include data, such as account information, transaction activity, payment activity, non-monetary activity and/or other relevant data for one or more accounts. While a single database is illustrated in the exemplary figure, the system may include multiple databases at the same location or separated through multiple locations. The databases may be further combined and/or separated. In addition, the databases may be supported by Financial Institution 130 or an independent service provider. For example, an independent service provider may support the one or more databases and/or other functionality at a remote location. Other architectures may be realized. The components of the exemplary system diagrams may be duplicated, combined, separated and/or otherwise modified, as desired by various applications of the embodiments of the present invention as well as different environments and platforms.

Processor 110 may communicate to various entities, including Account Specialist(s) 132, Merchant(s) 134, Credit Bureau(s) 136 and/or Other Sources 138. An embodiment of the present invention may also communicate to the Authorities 150, including police, law enforcement, FBI, terrorism bureaus, government entities and/or other entities. In addition, suspicious activity report (SAR) filings may be facilitated through an embodiment of the present invention, as shown by 152. Communication may be provided by Communication Network 122, 124, 126 and/or other communication mechanism. In addition, Processor 110 may have access to other sources of data and/or data feeds that identify other metrics and/or information that may be relevant for identifying fraud activities in accordance with an embodiment of the present invention.

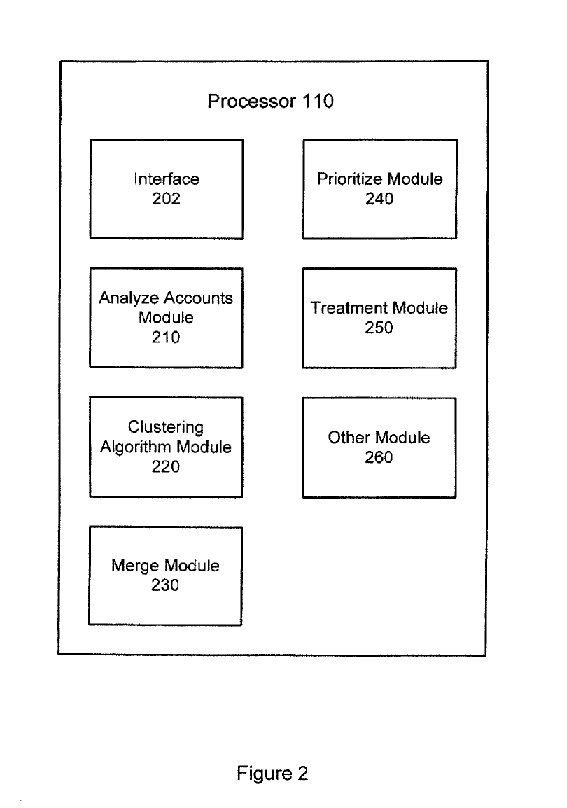

FIG. 2 is an exemplary detailed diagram of a processor for monitoring and/or detecting first party fraud, according to an embodiment of the present invention. For example, Processor 110 may include various modules and interfaces for analyzing data and identifying fraudulent and potentially fraudulent events, according to an embodiment of the present invention. Processor 110 may include Analyze Accounts 210, Clustering Algorithm 220, Merge Module 230, Prioritize Module 240, Treatment Module 250 and/or other modules, interfaces and/or processors, as represented by Other Module 260. While a single illustrative block, module or component is shown, these illustrative blocks, modules or components may be multiplied for various applications or different application environments. In addition, the modules or components may be further combined into a consolidated unit. Other architectures may be realized. The modules and/or components may be further duplicated, combined and/or separated across multiple systems at local and/or remote locations.

An embodiment of the present invention seeks to address fraudulent situations where an individual (or group of individuals) defrauds a financial institution, or other entity, without a third party victim. This is known as First Party Fraud, Bust Outs or Synthetic Fraud. First Party Fraud may include various levels of activity involving individuals, small groups as well as complex rings. For example, first party fraud may involve a rapid bust out. In this exemplary scenario, a customer may spend normally for an initial time period, e.g., the first few months, etc. The customer may then increase his spending pattern, transfer high balance on the account, issue large convenience checks and/or perform other actions. Through these actions or any combination thereof, the customer's OTB may be increased by way of a payment. When the payment bounces, a bust out has occurred. Another exemplary scenario may involve collusive merchant(s). In this example, a customer may spend normally and pay regularly. The customer may change his pattern by spending large amounts at a particular merchant, participate in high share of round-number transactions in states with sales tax, participate in high spend at low tenured merchants or merchants on a negative list and/or perform other actions. When the customer suddenly stops making payments, a bust out has occurred. In yet another exemplary scenario, first party fraud scams may last over an extended period of time, e.g., several years. In this type of first party fraud, a customer may spend regularly, often up to the line and pay diligently. The customer may request a line increase (which will be approved because of the customer's good credit) and/or there may be a flurry of activity on the customer's credit file. The customer may then spend rapidly to move towards the new credit limit and/or credit and payment inquiry calls may be received from various sources, including unknown sources. The customer may then make a payment with checks multiple times in a cycle. At this point, the customer's OTB may be increased. The customer may then attempt to open a new account anticipating account closure and/or increase his spending pattern. When the payments bounce, a bust out has occurred. Complex rings may involve ID creation, synthetic ID's, merchants, gangs, buying ID's, foreign rings, etc.

First party fraud is particularly difficult to detect because these fraudsters mimic best customer behavior. Large leveraged schemes generally involve many hard to link accounts. In addition, first party fraud is generally more sophisticated and hard to explain for easy law enforcement case creation. First party fraud typically goes undetected in large organizations for many years. Moreover, if most or all accounts in a ring are not closed within the same time frame, the remaining open accounts rapidly go bad.

According to another embodiment of the present invention, Processor 110 may host a website or other electronic interface, as shown by Interface 202, where users can access data as well as provide data. For example, a financial institution, merchant and/or other entity may access information through an interface to view data, submit requests, provide data and/or perform other actions.

Analyze Accounts 210 may perform analysis in accordance with the various embodiments of the present invention to detect, monitor and/or investigate fraud activities, including first party fraud. Accounts may be from one source (e.g., one financial institution, bank, merchant, provider, etc.) or multiple sources (e.g., affiliated financial institutions, banks, merchants, providers, etc.).

Clustering Algorithm 220 may represent the clustering or prediction algorithm of an embodiment of the present invention. An embodiment of the present invention may identify high risk clusters from otherwise unrelated accounts efficiently and accurately. For example, a clustering or prediction algorithm may accurately and quickly identify high risk accounts based on custom scoring. Scoring may be achieved mathematically utilizing various data. For instance, a score may be calculated using, for example, data fields, web data, payment information, etc. By finding a cluster and determining how data is grouped and/or maximizing these groups (or subgroups) using these scores, high risk clusters may be more accurately recognized. Furthermore, false positives may be reduced and less time may be wasted analyzing “good” accounts. The clustering algorithm further automates linking accounts, automates and simplifies SARs reporting and further provides a common web based interface.

The clustering algorithm of an embodiment of the present invention may link accounts and proactively monitor for abusive behavior. Using the clustering algorithm of an embodiment of the present invention within an abusive behavior arena may involve the complex scoring of links between individuals and events. The number of degrees of separation, frequency, types of connections, timing of connections, and/or other factors and considerations may be used to determine the strength of the cluster.

Merge Module 230 may merge results from the clustering algorithm into another source of data to provide a more accurate view of fraudulent activity. For example, the data may be merged with a credit score or other indication of credit, risk, etc. Prioritize Module 240 may prioritize the accounts or otherwise categorize the accounts into segments. For example, accounts with a higher probability of being a bust out may be prioritized. This may facilitate action and treatment.

Treatment Module 250 may identify and/or apply a recommended action based on the analysis performed by the clustering algorithm. An embodiment of the present invention provides for a more thorough investigation that will allow for better linking of accounts to ensure high risk accounts are properly identified and appropriate actions are taken (e.g., SARs are filed correctly). Moreover, earlier detection may lead to lower losses and damages. Another benefit provides a coordinated effort for recovery across multiple departments, including Authorizations, Retail, Payments, etc.

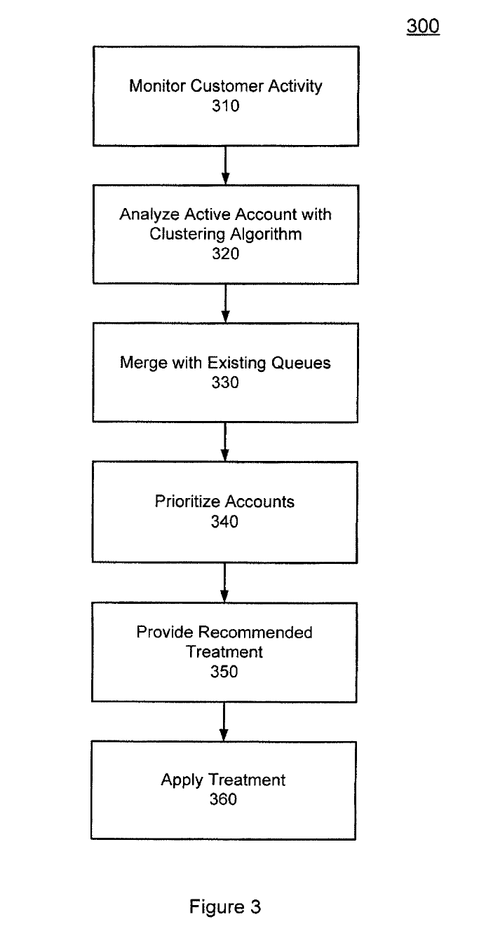

FIG. 3 is an exemplary flowchart illustrating a method for identifying fraudulent events 300, according to an embodiment of the present invention. At step 310, customer activity associated with one or more accounts may be monitored. At step 320, one or more active accounts may be analyzed with a clustering or prediction algorithm of an embodiment of the present invention. At step 330, the analysis performed at step 320 may be merged with other data, such as a credit score or other indication of risk. At step 340, the one or more accounts may be prioritized with one or more hints. At step 350, a list of linked accounts with suggested treatments may be provided. At step 360, the suggested treatment may be applied for each account. The order illustrated in FIG. 3 is merely exemplary. While the process of FIG. 3 illustrates certain steps performed in a particular order, it should be understood that the embodiments of the present invention may be practiced by adding one or more steps to the processes, omitting steps within the processes and/or altering the order in which one or more steps are performed. These steps will be described in greater detail below.

At step 310, customer activity associated with one or more accounts may be monitored. Customer activity may include various factors, such as transaction activity, payment activity and/or non-monetary activity.

At step 320, one or more active accounts may be analyzed with a clustering algorithm of an embodiment of the present invention. The clustering algorithm of an embodiment of the present invention may predict bust outs (and other fraudulent activities) in advance by monitoring customer activity patterns. For example, individual accounts may be monitored for patterns of activity that are indicative of bust outs. Monitoring may be performed daily (or at other intervals) using metrics that capture high-risk behavior indicative of a bust out.

Examples of metrics used in the bust out detection algorithm may include transaction activity, payment activity and/or non-monetary activity. Transaction activity may include: proportion of high-risk purchases (e.g., jewelry, gift cards, casinos, etc.), frequency of whole-value transactions, transaction velocity, use of convenience checks, use of balance transfers and/or other activities. Payment activity may include: payment frequency, payment amount, proportion/frequency of payment reversals and/or other activities. Non-monetary activity may include frequency of payment status inquiries, frequency of credit line increase requests, number of trade lines, geographic location and/or other activities.

Additional items for clustering inclusion may include other variables, such as: Full account data; Extended time frame of usage/contact information; Merchant information; Bureau information; External data sources; Previous addresses; Business license data; Transaction trends; Payee data; Aliases; public record information; Account velocity metrics—e.g., rapid change on same transactions; etc.; Negative Files; Internal/External Scores. Other math based items may include: Geographic/Proximity Modeling; Score based clusters; Clusters of clusters; Cluster migration score, etc.

An algorithm of an embodiment of the present invention may score active accounts. Accounts may be scored at intervals, such as each day, on request or at other times. Because a neural network algorithm may be implemented to provide a best linear fit by distributing data points generally around a line, in some embodiments, the line may be a simple curve rather than the straight line. The neural network algorithm may provide curve fitting by providing an additional node which has a suitably curved (nonlinear) activation function, such as an S-shaped hyperbolic tangent (tan h) function. In other embodiments, a network having an extra node with tan h activation function may be inserted between input and output. Such a node may be “hidden” inside the network having a weight from a bias unit. It should be appreciated that non-input neural network units may typically have such a bias weight.

As discussed above, by generating scores at intervals, the network may be “trained” to fit the tan h function to the data. It should be appreciated that the tan h function may not fit all the data and having too large a hidden layer (or too many hidden layers) may ultimately degrade the network's performance. Therefore, it should be appreciated that using no more hidden units than is necessary to solve a given problem is beneficial. Accordingly, when applied to risk detection, the algorithm used in the neural network may score active accounts with accuracy and reliability.

An embodiment of the present invention may be directed to preparing data, developing a prediction algorithm and evaluating the prediction algorithm. According to an exemplary embodiment of the present invention, random accounts and/or charged off accounts may be sampled. This may involve an analysis period where information for a period of time, e.g., the last 2 years, may be analyzed. Using information from the accounts, an embodiment of the present invention may create bust-out attributes. The analysis may be limited to days when the account has payment and/or purchase activity. Predicators may be normalized by using mean and standard deviation calculations. The dataset used to train the prediction model of an embodiment of the present invention may include account days of information for bust out accounts. The days selected may be the days leading up to the bust out. The prediction algorithm of an embodiment of the present invention may be developed by creating the train and test datasets with a set of predictors. Model specifications, including hidden nodes, training parameters and number of inputs, may be assigned. A neural model network may be executed which may include model performance estimates, e.g., root mean square, and neural network model scoring equation. Performances may be compared. Multiple neural network specifications may be designed and evaluated to finalize an optimal model.

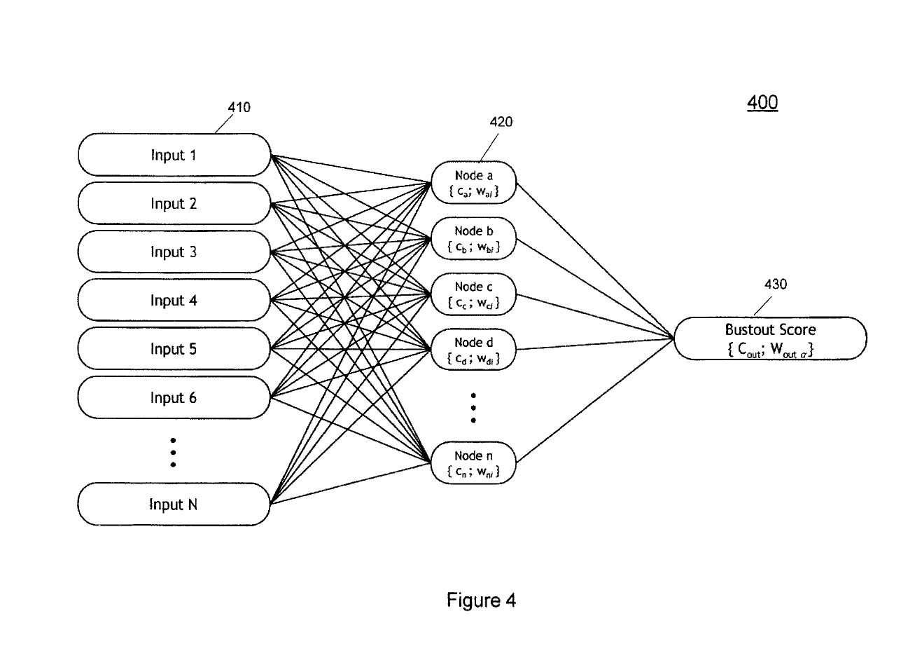

FIG. 4 is an exemplary diagram illustrating a bust out prediction method 400, according to an embodiment of the present invention. The bust out predation method 400 may include one or more inputs 410, one or more nodes or “neurons” 420, and a bust out (BO) score 430. It should be appreciated that there may be N number of inputs 410 and n number of nodes 420 to generate the bust out score 430. In some embodiments, a bust out scoring equation may be represented by:

BO Score=tan h(Cₒᵤₜ+Σ_{α=a to n}w_{out α}tan h(Cα+Σ_{i=1 to N}W_{αi}Inputᵢ)).

Here, the equation may be a mathematical algorithm utilized, for example, in SAS. In other words, no additional T resources may be required. As discussed above, a neural network algorithm may be used to score all active accounts each teach. Each node of neuron, which may receive the input values and transform them into an output, may use a mathematical formula, as expressed by the equation above. The output node may then receive output values from each of the neurons and transform them into a final BO score 430 (again through a mathematical formula), which may be expressed by the bust out prediction method 400 of FIG. 4.

The prediction algorithm may then be evaluated for active accounts in accordance with an embodiment of the present invention. Active accounts may be selected in a out-of-time month. A bust out score 430 may be calculated for the accounts using the neural network model equation. Post spend and balance on the day of scoring may be derived for impact estimation and savings.

An embodiment of the present invention may identify an optimal set of predictive information. A set of variables (e.g., 275 variables, or other number of variables) may be created based on information accumulated during a bust out problem sizing phase. For example, a universe of information and data with various variables may be made smaller to greater manageability (e.g., 42 inputs and 275 variables). These variables attempt to capture changes in customer behavior, background customer information (e.g., through credit bureau data) and/or other information. Next, the value of the variables may be calculated for a set of sample accounts (e.g., each account in the training dataset) and a corresponding bust out flag may be determined. Finally, a logistic regression may be executed on the dataset created for model training, which may include values for the input variables and their corresponding bust out. The inputs having a confidence level above a predetermined threshold (e.g., 95%) may be kept and applied. According to an exemplary application, 42 of the 275 inputs may be applied in the clustering or prediction algorithm of an embodiment of the present invention.

A list of exemplary inputs 410 used in the clustering or prediction algorithm may include a combination of the following:

| | | |
|---|---|---|
| 1 | RL30_90_AUTH_CA_CN | Avg number of cash authorizations in last 30 days |
| | | [over] average number of cash authorizations in last 90 |
| | | days |
| 2 | INQR_BC_PRI_12_MO_CN | Bank and credit inquiries in last 12 months |
| 3 | RL30_line_TR_AM | Amount of transactions in last 30 days [OVER] credit |
| | | limit |
| 4 | TL5_Payment_Reverse_CN | Number of payments reversed in past 5 days |
| 5 | ATTR_76 | Number of satisfactory trades opened prior to 5 |
| | | months |
| 6 | ATTR_73 | Total number of revolving bankcard trades |
| 7 | RL30_90_AUTH_DCL_AM | Avg amount of declined authorizations in last 30 days |
| | | [over] average amount of declined authorizations in |
| | | last 90 days |
| 8 | RL5_30_AUTH_PR_CN | Avg number of purchase authorizations in last 5 days |
| | | [over] average number of purchase authorizations in |
| | | last 30 days |
| 9 | E202 | Number inquiries in 6 months |
| 10 | TL90_Fraud_CNT | Total fraud count in last 90 days |
| 11 | TL90_CC_CN | Total convenience check count in last 90 days |
| 12 | RL30_line_Payment_Reverse_AM | Payment reversal by credit line in last 30 days |
| 13 | RL30_90_W10_CN | Number of whole 10 dollar transactions in last 30 days |
| | | [over] average daily number of whole 10 dollar |
| | | transactions in past 90 days |
| 14 | AT04_13 | Average date open on all tradelines |
| 15 | AT54_26 | Total number of trades |
| 16 | ATTR_1 | Total balance of revolving bankcard |
| 17 | TL90_ALL_NON_MNTR_CNT | Total non-monetary activity count in last 90 days |
| 18 | RL5_TOT_Purchase_CAJ_CN | Credit adjustment count [over] total count of |
| | | transactions in last 5 days |
| 19 | RL5_30_Gross_CA_CN | Number of cash transactions in last 5 days [over] |
| | | average daily number of transactions in past 30 days |
| 20 | RL1_line_BT_AM | Amount of balance transfers in last day [over] credit |
| | | limit |
| 21 | TL90_Gross_Payment_CN | Number of payments in last 90 days |
| 22 | RL10_line_Gross_Payment_AM | Payment amount in last 10 days [over] credit limit |
| 23 | TL90_Payment_Reverse_CN | Payment reversal count in last 90 days |
| 24 | RL30_TOT_AUTH_DCL_AM | Amount of declined authorizations in last 30 days |
| | | [over] total amount of authorizations in last 30 days |
| 25 | ATTR_18 | Number of open internal trades reported in 6 months. |
| 26 | RL30_90_AUTH_BAL_CN | Avg number of balance inquiry authorizations in last |
| | | 30 days [over] average number of balance inquiry |
| | | authorizations in last 90 days |
| 27 | TL5_ALL_NON_MNTR_CNT | Number of calls in past 5 days |
| 28 | RL30_90_W10_AM | Amount of whole 10 dollar transactions in last 30 days |
| | | [over] average daily amount of whole 10 dollar |
| | | transactions in past 90 days |
| 29 | ATTR_12 | Number of inquiries reported in the last 4 months |
| 30 | RL30_90_AUTH_REF_CN | Avg number of referred authorizations in last 30 days |
| | | [over] average number of referred authorizations in |
| | | last 90 days |
| 31 | AT50_26 | Age of oldest trade. |
| 32 | RL30_90_AUTH_AM | Avg amount of authorizations in last 30 days [over] |
| | | average number of authorizations in last 90 days |
| 33 | RL30_90_AUTH_APR_CN | Avg number of approved authorizations in last 30 days |
| | | [over] average number of approved authorizations in |
| | | last 90 days |
| 34 | RL5_TOT_CA_CAJ_AM | Cash credit adjustment amount [over] total amount in |
| | | last 5 days |
| 35 | RL5_TOT_CA_CAJ_CN | Cash credit adjustment count [over] total transaction |
| | | count in last 5 days |
| 36 | RL5_30_AUTH_REF_CN | Avg number of referred authorizations in last 5 days |
| | | [over] average number of referred authorizations in |
| | | last 30 days |
| 37 | RL5_30_Gross_CA_AM | Amount of cash transactions in last 5 days [over] |
| | | average daily amount of transactions in past 30 days |
| 38 | RL1_5_AUTH_REF_CN | Number of referred authorizations in last day [over] |
| | | average number of referred authorizations in last 5 |
| | | days |
| 39 | RL5_TOT_Gross_CA_AM | Cash amount [over] total spend in last 5 days |
| 40 | RL1_TOT_CA_CAJ_CN | Cash credit adjustment count [over] total count in last |
| | | 1 days |
| 41 | RL5_30_W_CN | Number of whole dollar transactions in last 5 days |
| | | [over] average daily number of whole dollar |
| | | transactions in past 30 days |
| 42 | RL5_TOT_HIGH_RISK_CN | High-risk transactions count [over] total transaction |
| | | count in last 5 days |

The above list represents an exemplary set of optimal 42 inputs. According to other embodiments and applications, other inputs and modifications to the above inputs may be applied in accordance with embodiments of the present invention. Other numbers of inputs (greater than or less than 42 inputs) may be applied as well.

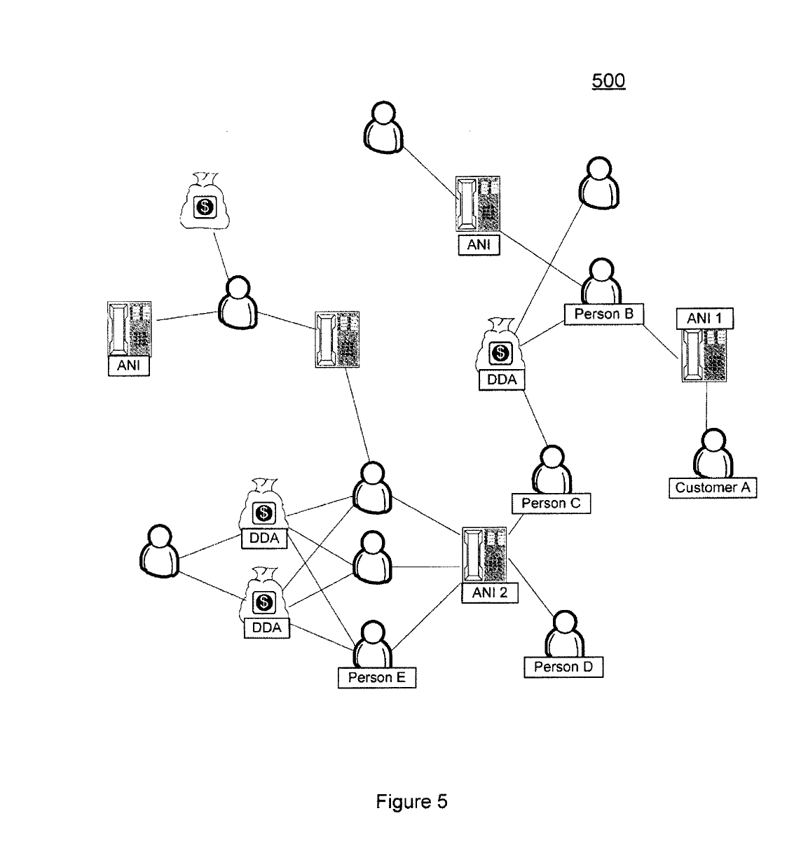

FIG. 5 is an exemplary interface illustrating a clustering algorithm, according to an embodiment of the present invention. For example, a known bad customer may be used to link other associated accounts and/or customers. For example, customer A may represent a known fraudster. The known bad, customer A, may use a particular phone number or Automatic Number Identification (ANI), as shown by ANI 1. This ANI 1 may also be used or otherwise associated with another individual, person B. Person B may be associated with a Demand Deposit Account (DDA) 1, which has been accessed or otherwise associated with Person C. Person C may use an ANI 2, which is associated with Persons D and E. This exemplary diagram illustrates multiple contacts, high frequency and multiple touch points associated with a known bad.

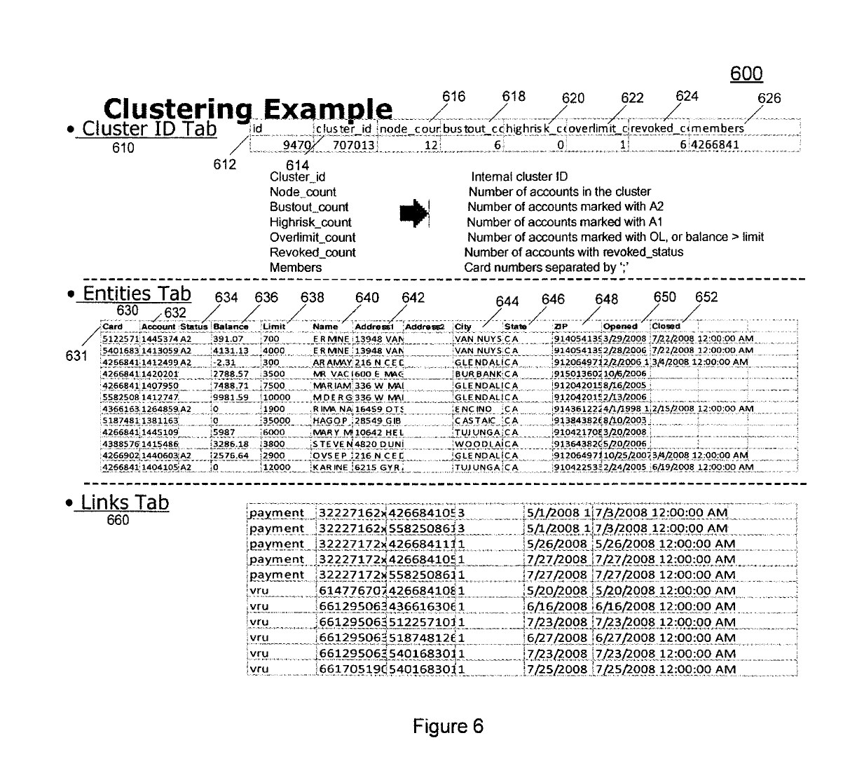

FIG. 6 is an exemplary interface illustrating detailed cluster data 600, according to an embodiment of the present invention. Once the links are identified, additional detailed information for each player or potential player may be further analyzed, as shown by FIG. 6. FIG. 6 illustrates a clustering example with cluster ID tab 610, Entities Tab 630 and Links Tab 660. Other tabs and/or data may also be analyzed and displayed.

Each account may be further analyzed to determine cluster information. For example, under Cluster ID Tab 610, clustering information may include an id 612, cluster id 614 (internal cluster ID), node count 616 (number of accounts in the cluster), bust out count 618 (number of accounts marked with A2), highrisk count 620 (number of accounts marked with A1), overlimit account 622 (Number of accounts marked with over limit (OL) or balance great than the limit), revoked count 624 (number of accounts with revoked status), 626 members (card numbers separated by “;”) and/or other clustering data.

Entities Tab 630 may include card 631, account 632, status 634 (e.g., A1, A2, etc.), balance 636, limit 638, name 640, address 642, city 644, state 646, zip 648, open date 650 and closed date 652. For example, a list of products associated with each player may be analyzed.

Links Tab 660 may include information showing commonalities between various accounts. For example, an analyst may use the links tab to see how various accounts are linked with each other.

At step 330, the analysis performed at step 320 may be merged with other data, such as a credit score or other indication of risk. According to an exemplary embodiment, the analysis generated with the predicative model of an embodiment of the present invention, which may be represented as a score or other indicator, may be merged with a credit score, such as an Experian™ score. Other credit scores, risk scores, indicators and/or measures of credit, risk, debt, status, etc. may be used.

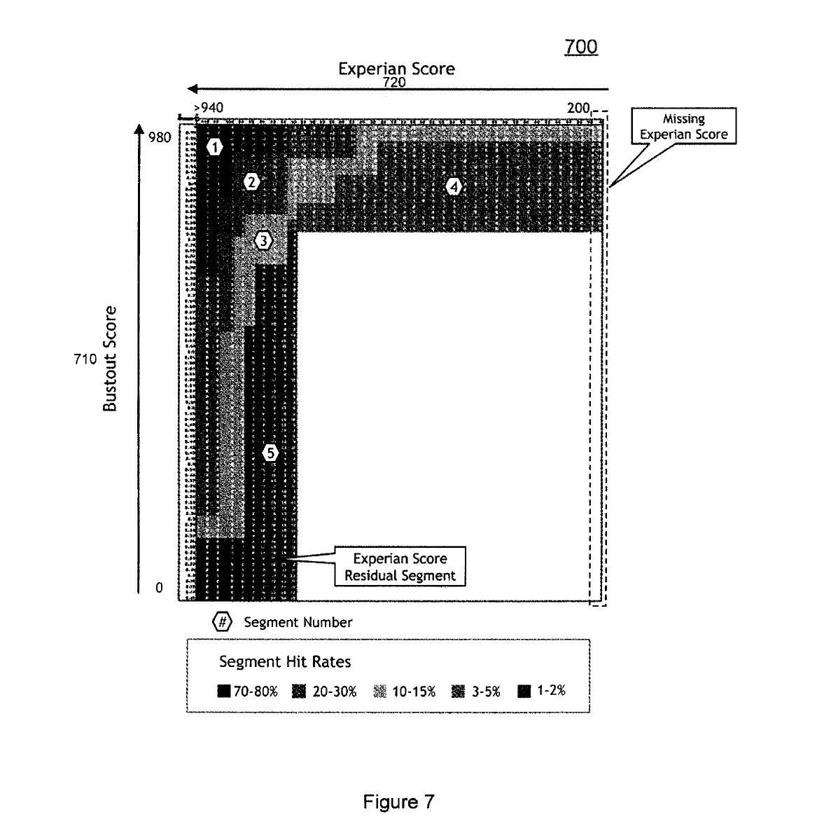

FIG. 7 illustrates merging a clustering or prediction model with a credit score, according to an embodiment of the present invention. According to an exemplary embodiment of the present invention, segments may be created based on the joint use of the score from the predictive model of an embodiment of the present invention, as shown by 710, and of a credit score, e.g., the Experian score, as shown by 720. For example, as illustrated in FIG. 7, five segments may be identified. The segment hit rates may include Segment 1: 70-80%; Segment 2: 20-30%; Segment 3: 10-15%; Segment 4: 3-5% and Segment 5: 1-2%. Hit rate may represent number of bust outs captured as compared to a total number of accounts queued. An embodiment of the present invention applies a segmented treatment based on the probability of an account being a bust out. For segment 1, the segment treatment may include “block authorizations.” For segment 2 and 3, the segment treatment may be “float payments.” For segments 4 and 5, the segment treatment may be a “review.” Other segments may be identified and the segments discussed above may be merged into fewer segments, in accordance with the various embodiments of the present invention.

At step 340, the one or more accounts may be prioritized with one or more hints. For example, accounts with a higher probability of being a bust out maybe prioritized higher. According to an embodiment of the present invention, accounts may be scored with the predictive model of an embodiment of the present invention, prioritized and supplied to one or more analysts with hints. For example, accounts that are forecast to present a high bust out risk will afford analysts a better understanding on why the account was queued, enable the analyst to target their account review and thus improve productivity. Exemplary hints may include number of trades, number of inquiries, number of high risk transactions, number of high payments and/or other data that may be helpful in determining why the account received a particular score. Hints may also provide a number of links and/or show frequency of magnitude of contact information, for example, to provide a greater probability for determining bust out. In other words, hints may provide analysts a good starting place for analysis and improve efficiency. Other various embodiments may also be provided.

At step 350, a list of linked accounts with suggested treatments may be provided. Process efficiency can be improved by providing recommended treatment options and by following up on these recommendations to increase analyst confidence in the pre-specified treatment strategies.

At step 360, the suggested treatment may be applied for each account. According to an embodiment of the present invention, a full cluster may be pulled upon suspicion of one or more accounts for review and/or automated action. For example, manual review may involve analysis by a trained individual. Automated actions may include usage monitoring, law enforcement involvement, changes to account settings, tracking, automated SAR filing, authority reporting for illegal and/or other activity. According to an embodiment of the present invention, a portfolio may be monitored for clustering creations, changes, and migrations. An embodiment of the present invention facilitates case display for law enforcement to follow and act on.

According to an embodiment of the present invention, reactive benefits may include reduction or elimination of analyst fatigue resulting in missed related accounts; faster cluster creation; easy law enforcement case presentment; and quicker and more accurate identification of fraudulent activities. According to an embodiment of the present invention, proactive benefits may include creation of high risk clusters for analysis and monitoring of potential high risk clusters for more stringent policies.

While the exemplary embodiments illustrated herein may show the various embodiments of the invention (or portions thereof) collocated, it is to be appreciated that the various components of the various embodiments may be located at distant portions of a distributed network, such as a local area network, a wide area network, a telecommunications network, an intranet and/or the Internet, or within a dedicated object handling system. Thus, it should be appreciated that the components of the various embodiments may be combined into one or more devices or collocated on a particular node of a distributed network, such as a telecommunications network, for example. As will be appreciated from the following description, and for reasons of computational efficiency, the components of the various embodiments may be arranged at any location within a distributed network without affecting the operation of the respective system.

Data and information maintained by Processor 110 may be stored and cataloged in Database 140 which may comprise or interface with a searchable database. Database 140 may comprise, include or interface to a relational database. Other databases, such as a query format database, a Standard Query Language (SQL) format database, a storage area network (SAN), or another similar data storage device, query format, platform or resource may be used. Database 140 may comprise a single database or a collection of databases, dedicated or otherwise. In one embodiment, Database 140 may store or cooperate with other databases to store the various data and information described herein. In some embodiments, Database 140 may comprise a file management system, program or application for storing and maintaining data and information used or generated by the various features and functions of the systems and methods described herein. In some embodiments, Database 140 may store, maintain and permit access to customer information, transaction information, account information, and general information used to process transactions as described herein. In some embodiments, Database 140 is connected directly to Processor 110, which, in some embodiments, it is accessible through a network, such as communication network, e.g., 122, 124, 126 illustrated in FIG. 1, for example. Communications network, e.g., 122, 124, 126, may be comprised of, or may interface to any one or more of, the Internet, an intranet, a Personal Area Network (PAN), a Local Area Network (LAN), a Wide Area Network (WAN), a Metropolitan Area Network (MAN), a storage area network (SAN), a frame relay connection, an Advanced Intelligent Network (AIN) connection, a synchronous optical network (SONET) connection, a digital T1, T3, E1 or E3 a Digital Data Service (DDS) connection, a Digital Subscriber Line (DSL) connection, an Ethernet connection, an Integrated Services Digital Network (ISDN) line, a dial-up port such as a V.90, a V.34 or a V.34bis analog modem connection, a cable modem, an Asynchronous Transfer Mode (ATM) connection, a Fiber Distributed Data Interface (FDDI) connection, or a Copper Distributed Data Interface (CDDI) connection.

Communications network, e.g., 122, 124, 126, may also comprise, include or interface to any one or more of a Wireless Application Protocol (WAP) link, a General Packet Radio Service (GPRS) link, a Global System for Mobile Communication (GSM) link, a Code Division Multiple Access (CDMA) link or a Time Division Multiple Access (TDMA) link such as a cellular phone channel, a Global Positioning System (GPS) link, a cellular digital packet data (CDPD) link, a Research in Motion, Limited (RIM) duplex paging type device, a Bluetooth radio link, or an IEEE 802.11-based radio frequency link. Communications network 107 may further comprise, include or interface to any one or more of an RS-232 serial connection, an IEEE-1394 (Firewire) connection, a Fibre Channel connection, an infrared (IrDA) port, a Small Computer Systems Interface (SCSI) connection, a Universal Serial Bus (USB) connection or another wired or wireless, digital or analog interface or connection.

In some embodiments, communication network, e.g., 122, 124, 126, may comprise a satellite communications network, such as a direct broadcast communication system (DBS) having the requisite number of dishes, satellites and transmitter/receiver boxes, for example. Communications network, e.g., 122, 124, 126, may also comprise a telephone communications network, such as the Public Switched Telephone Network (PSTN). In another embodiment, communication network 120 may comprise a Personal Branch Exchange (PBX), which may further connect to the PSTN.

In some embodiments, Processor 110 may include any terminal (e.g., a typical home or personal computer system, telephone, personal digital assistant (PDA) or other like device) whereby a user may interact with a network, such as communications network, e.g., 122, 124, 126, for example, that is responsible for transmitting and delivering data and information used by the various systems and methods described herein. Processor 110 may include, for instance, a personal or laptop computer, a telephone, or PDA. Processor 110 may include a microprocessor, a microcontroller or other general or special purpose device operating under programmed control. Processor 110 may further include an electronic memory such as a random access memory (RAM) or electronically programmable read only memory (EPROM), a storage such as a hard drive, a CDROM or a rewritable CDROM or another magnetic, optical or other media, and other associated components connected over an electronic bus, as will be appreciated by persons skilled in the art. Processor 110 may be equipped with an integral or connectable cathode ray tube (CRT), a liquid crystal display (LCD), electroluminescent display, a light emitting diode (LED) or another display screen, panel or device for viewing and manipulating files, data and other resources, for instance using a graphical user interface (GUI) or a command line interface (CLI). Processor 110 may also include a network-enabled appliance, a browser-equipped or other network-enabled cellular telephone, or another TCP/IP client or other device.

As described above, FIG. 1 shows embodiments of a system of the invention. The system of the invention or portions of the system of the invention may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above in the flowcharts. Such a set of instructions for performing a particular task may be characterized as a program, software program, or simply software.

As noted above, the processing machine executes the instructions that are stored in the memory or memories to process data. This processing of data may be in response to commands by a user or users of the processing machine, in response to previous processing, in response to a request by another processing machine and/or any other input, for example. As described herein, a module performing functionality may comprise a processor and vice-versa.

As noted above, the processing machine used to implement the invention may be a general purpose computer. However, the processing machine described above may also utilize any of a wide variety of other technologies including a special purpose computer, a computer system including a microcomputer, mini-computer or mainframe for example, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the process of the invention.

It is appreciated that in order to practice the method of the invention as described above, it is not necessary that the processors and/or the memories of the processing machine be physically located in the same geographical place. That is, each of the processors and the memories used in the invention may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing as described above is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; e.g., so as to obtain further instructions or to access and use remote memory stores, for example. Such technologies used to provide such communication might include a network, the Internet, Intranet, Extranet, LAN, an Ethernet, or any client server system that provides communication, for example. Such communications technologies may use any suitable protocol such as TCP/IP, UDP, or OSI, for example.

As described above, a set of instructions is used in the processing of the invention. The set of instructions may be in the form of a program or software. The software may be in the form of system software or application software, for example. The software might also be in the form of a collection of separate programs, a program module within a larger program, or a portion of a program module, for example The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, a EPROM, a wire, a cable, a fiber, communications channel, a satellite transmissions or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, voice reader, voice recognizer, dialogue screen, menu box, list, checkbox, toggle switch, a pushbutton or any other device that allows a user to receive information regarding the operation of the processing machine as it processes a set of instructions and/or provide the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications and equivalent arrangements.

The embodiments of the present inventions are not to be limited in scope by the specific embodiments described herein. For example, although many of the embodiments disclosed herein have been described with reference to identifying fraudulent activities, the principles herein are equally applicable to other applications. Indeed, various modifications of the embodiments of the present inventions, in addition to those described herein, will be apparent to those of ordinary skill in the art from the foregoing description and accompanying drawings. Thus, such modifications are intended to fall within the scope of the following appended claims.

Further, although the embodiments of the present inventions have been described herein in the context of a particular implementation in a particular environment for a particular purpose, those of ordinary skill in the art will recognize that its usefulness is not limited thereto and that the embodiments of the present inventions can be beneficially implemented in any number of environments for any number of purposes. Accordingly, the claims set forth below should be construed in view of the full breadth and spirit of the embodiments of the present inventions as disclosed herein.

1.-22. (canceled)

23. A method comprising:
training, using a computer processor, a prediction model to identify potentially fraudulent transactions from non-fraudulent transactions;
clustering, using a computer processor, transactions into clusters wherein each cluster is formed by grouping transactions with common factors;
generating, using a computer processor, a score representative of how data is grouped in each cluster; and
generating, using a computer processor, an optimal set of predictors based at least in part on the score for identifying potentially fraudulent transactions.

24. The method of claim 23, wherein the prediction model is a neural network.

25. The method of claim 24, wherein the neural network provides a best linear fit by distributing data points around a line wherein the line is a straight line or a curved line.

26. The method of claim 23, wherein the optimal set of predictors are normalized by using means and standard deviation calculations.

27. The method of claim 23, further comprising the step of:
executing the predication model using a plurality of model performance estimates to generate a plurality of performances; and
comparing the plurality of performances to identify an optimal model.

28. The method of claim 27, wherein the plurality of model performance estimates comprises a root mean square.

29. The method of claim 27, wherein the plurality of model performance estimates comprises a neural network model scoring equation.

30. The method of claim 23, wherein the optimal set of predictors comprises a set of variables representing customer behavior.

31. The method of claim 23, wherein the optimal set of predictors comprises a set of variables representing background customer information.

32. The method of claim 23, wherein the clusters represent links within a central location.

33. A system comprising:
a processor;
a storage medium for tangibly storing thereon program logic for execution by the processor, the program logic comprising logic for:
training, using a computer processor, a prediction model to identify potentially fraudulent transactions from non-fraudulent transactions;
clustering, using a computer processor, transactions into clusters wherein each cluster is formed by grouping transactions with common factors;
generating, using a computer processor, a score representative of how data is grouped in each cluster; and
generating, using a computer processor, an optimal set of predictors based at least in part on the score for identifying potentially fraudulent transactions.

34. The system of claim 33, wherein the prediction model is a neural network.

35. The system of claim 34, wherein the neural network provides a best linear fit by distributing data points around a line wherein the line is a straight line or a curved line.

36. The system of claim 33, wherein the optimal set of predictors are normalized by using means and standard deviation calculations.

37. The system of claim 33, further comprising the step of:
executing the predication model using a plurality of model performance estimates to generate a plurality of performances; and
comparing the plurality of performances to identify an optimal model.

38. The system of claim 37, wherein the plurality of model performance estimates comprises a root mean square.

39. The system of claim 37, wherein the plurality of model performance estimates comprises a neural network model scoring equation.

40. The system of claim 33, wherein the optimal set of predictors comprises a set of variables representing customer behavior.

41. The system of claim 33, wherein the optimal set of predictors comprises a set of variables representing background customer information.

42. The system of claim 23, wherein the clusters represent links within a central location.
